(19) United States
(12) Patent Application Publication
(10) Pub. No.: US 2008/0131582 A1
(43) Pub. Date: Jun. 5, 2008

(54) Production of whole grain hot cereal products

(76) Inventors: Jan Karwowski, Midland Park, NJ (US); Vani Vemulapalli, Whippany, NJ (US); Karen Kay Kane, Battle Creek, MI (US)

Correspondence Address: BELL, BOYD & LLOYD, LLP, P.O. Box 1135, CHICAGO, IL, 60690, US

(21) Appl. No.: 11/634,065

(22) Filed: Dec. 5, 2006

(51) Int. Cl. A23L 1/10; A23L 1/172

(52) U.S. Cl. 426/622

(57) ABSTRACT

A dry, whole grain hot cereal product which readily hydrates into a creamy, non-gritty, non-pasty, whole grain hot cereal is produced by milling whole cereal grains or combining separate streams or sources of endosperm, bran and germ to obtain a milled whole grain mixture having a particle size distribution of 100% by weight through a No. 16 (1,190 micron), preferably a No. 18 (1,000 micron), most preferably a No. 20 (841 micron) U.S. Standard Sieve, and less than or equal to about 7% by weight through a No. 100 (149 micron) U.S. Standard Sieve. The endosperm, the bran and the germ may be stabilized before or after milling of the whole grains or the endosperm, the bran and the germ, to avoid insect infestation and to at least substantially inactivate lipase and lipoxygenase. The dry, whole grain hot cereal product may be a cook-on-stove or instant hot cereal product.

### FIELD OF THE INVENTION

The present invention relates to processes for making stabilized, whole grain hot cereal products which are readily hydratable into creamy, smooth textured, whole grain hot cereals. The present invention also relates to stabilized, particulate, whole grain hot cereal products which are readily hydratable into creamy, smooth textured, whole grain hot cereals either by cooking on a stove or by addition of hot water, such as a creamy, instant whole wheat product.

### BACKGROUND OF THE INVENTION

Hot cereal products, except those made with oats, sold in the market are generally not 100% whole grain. They are generally made with the endosperm component of the grain ground to a certain particle size without the bran and germ components, such as the instant, flaked wheat farina products disclosed in U.S. Pat. Nos. 4,551,347, 4,590,088, 4,614,664, and 4,664,931 each to Karwowski. Vitamins and minerals may be added to enrich the hot cereal products. In some hot cereals defatted germ or bran may be added to enhance the nutritive value of the product. For example, in the production of instant hot cereals prepared from wheat farina or farina-like products, such as wheat middlings, the Federal Specification for farina requires that 100% of the product pass through a U.S. Standard No. 20 woven-wire-cloth sieve, not more than 10.0 percent pass through a U.S. Standard No. 45 sieve, and not more than 3.0 percent pass through a U.S. Standard No. 100 sieve. The wheat middlings are chunks of endosperm free of bran and germ.

Although whole grain food products are good sources of nutrients such as calcium, potassium, fiber, magnesium and vitamins A, C, and E, and are recommended by the USDA 2005 dietary guidelines as constituting half of a person's grain consumption, certain qualities of whole grain foods are undesirable. The presence of bran and germ in whole grain products may impart a coarse, gritty appearance and texture to the products. In the production of a hot cereal, formation of a course matrix, bound by a fine matrix to create a creamy, smooth texture without lumps is highly desirable. Milling of whole grain to reduce particle size of the harder bran and germ may result in making the endosperm too fine to meet the farina standard or result in a mushy, pasty texture which tends to form excessively large lumps.

In addition, milling of whole grains tends to decrease stability of the whole grain products resulting from the milling. Decreasing particle size increases the rate and extent of the deterioration of grain components. Nature has provided a number of protective features in seeds to prevent rancidity and spoilage, enabling seeds to survive periods of adverse conditions before attaining an appropriate environment for germination and growth. Rancidity is less likely to develop when lipid materials, for example, seed oil, are unable to interact with reactants or catalysts such as air and enzymes. One protective feature in cereal grains is the provision of separate compartments for storing lipids and enzymes so that they cannot interact.

Milling cereal grains involves breaking down the separate compartments, bran, germ and endosperm, such that the lipid and enzymatic components of the grain are able to interact, greatly increasing the development of rancidity. Increasing milling to reduce grittiness caused by bran particles tends to increase surface area, reduce natural encapsulation of lipids, and increase interaction between the lipids and enzymatic components thereby increasing the development of rancidity.

Thus, whole grain hot cereals, that is, those containing substantial amounts of bran and germ, are less stable than hot cereals made up of essentially endosperm, such as wheat farina hot cereals, especially as particle size is reduced to eliminate coarseness or to meet a Federal government farina particle size requirement. Prolonged storage of whole grain hot cereal products often leads to the development of rancidity. Rancidity includes adverse quality factors arising directly or indirectly from reactions with endogenous lipids, producing a reduction in cooking quality of hot cereal products, undesirable tastes and odors, and/or unacceptable functional properties. A main reason for the development of rancidity is the enzymatic degradation of unstable natural oils. Rich supplies of unstable natural oils are contained in the germ portion of grains. Hot cereal products made predominantly from the endosperm portion of wheat grains or other grains, such as wheat middlings, are generally substantially free of bran and germ, and therefor contain little or no unstable natural oils or fats.

Another reason rancidity is a greater problem in products derived from bran and germ-containing milled whole wheat is that bran and germ contain the enzymes involved in enzyme-catalyzed lipid degradation. One of the enzymes, lipase, causes hydrolytic rancidity in milled products of sound, ungerminated wheat. Lipase is found almost exclusively in the bran component. The other key lipid-degrading enzyme, lipoxygenase (LPO), is present almost exclusively in the germ and also is involved in the development of rancidity. Thus, bran-containing milled wheat hot cereal products are much more susceptible to the development of rancidity than are hot cereal products which contain little or no bran and germ.

Enzyme-catalyzed lipid degradation causing rancidity in whole wheat hot cereal products is believed to occur by the action of lipase followed by the action of LPO. When lipase, the enzyme found almost exclusively in the bran portion of the grain, is activated during milling, it reacts with unstable oils naturally occurring in the grain and breaks down the unstable oils to free fatty acids (FFA). This process may take weeks or even months. Then, LPO, the enzyme found almost exclusively in the germ portion of the grain, oxidizes FFA in the presence of oxygen, producing volatile breakdown products such as peroxides that, in turn, generate rancid aldehydes. In the absence of moisture, oxidation of FFA is also a very slow process and can take up to several weeks until noticeable amounts of rancid aldehydes can be detected. However, in the presence of moisture, or water, that is normally added to milled whole grains in large amounts during the hydration or cooking stage of hot cereal products, enzyme-catalyzed oxidation of free fatty acids may proceed to a great extent very quickly, causing formation of large amounts of rancid aldehydes in a matter of just a few minutes.

U.S. Pat. No. 4,834,988 to Karwowski et al discloses the production of a hot cereal by treating a cereal grain with a slurry resulting from the treatment of a grain-water mixture with starch-converting enzymes, heating the mixture until the grain is at least partially cooked, flaking the cooked cereal, and, optionally, agglomerating the flakes. The treatment of the raw grains with the enzyme processed slurry, it is disclosed, provides cereal which has a richer nutty flavor and, from a texture point of view, is less gummy when being consumed. The process requires enzymatic treatment of cereal grains, and does not employ any substantial milling prior to cooking or flaking which tends to result in a coarse or gritty texture rather than a creamy, smooth texture.

U.S. Pat. No. 4,603,055 to Karwowski et al discloses the production of a mixed grain instant hot cereal product by cutting different grains by a steel cutting method, mixing the dry grains together, steaming the mixture, rolling the cooked grains on a flaking roller to form flakes, and baking the flakes. The process, it is disclosed, produces thicker than normal toasted flakes of high flake integrity that withstand packaging, shipping and rehydration cooking. Use of steel cut grains rather than milled grains tends to result in a hot cereal with a coarse or gritty texture rather than a creamy, smooth texture.

U.S. Patent Application Publication Nos. US 2005/0136173 A1 and US 2005/0136174 A1, each to Korolchuk, disclose production of an ultrafine-milled whole-grain wheat flour and the products thereof. Ultrafine is defined as having a particle size of less than or equal to about 150 microns. The process is a continuous flow-grain-milling process, including the steps of separating a quantity of cleaned and tempered wheat kernels into a fine fraction, comprised primarily of endosperm along with small amounts of residual bran and germ, and a coarse fraction, comprising bran, germ, and a small amount of residual endosperm. The coarse fraction is ground through a mill, such as a gap mill, to form an ultrafine-milled coarse fraction having a particle size of less than or equal to about 150 micron. Finally, the ultrafine-milled coarse fraction is mixed with the fine fraction in order to form the ultrafine-milled whole-grain wheat flour. In the Korolchuk processes, the two fractions are milled to produce fractions and an ultrafine-milled whole-grain wheat flour having particle sizes less than or equal to about 150 microns. According to Korolchuk, the flour has the full nutritional value of wheat kernels, while retaining the texture of refined wheat flour and an appearance similar to refined wheat flour, and thus, the flour can be used in food products such as bakery products and snack food products, and ready-to-eat cereals which typically use refined wheat flour. However, production of a hot cereal product is not disclosed, and use of such a fine particle size whole wheat flour in the production of hot cereal products would result in a hot cereal having a mushy, pasty texture and mouthfeel, with undesirable lumps. Also, grinding of the coarse fraction to a particle size of less than or equal to about 150 microns causes increased interaction between the lipids and lipid-degrading enzymes, which results in increased rancidity problems.

U.S. Patent Application Publication No. US 2006/0073258 A1, to Korolchuk, discloses the production of an ultrafine-milled whole-grain wheat flour which has the full nutritional value of wheat kernels, while retaining the texture of refined wheat flour and an appearance similar to refined wheat flour. Production of an ultrafine-milled coarse fraction which can be used as a replacement and to fortify refined wheat flour is also disclosed. An objective of the Korolchuk process is to obtain an ultrafine-milled whole grain wheat flour that has a particle size distribution that meets the FDA standards for a refined wheat flour product of a particle size in which not less than 98% passes through a U.S. Wire 70 sieve (210 microns). In the Korolchuk process, an ultrafine-milled fine fraction comprising endosperm and a coarse fraction comprising bran and germ are obtained. The coarse fraction is ground in a gap mill to reduce microbial load, and the ultrafine-milled coarse fraction is then mixed with the ultrafine-milled fine fraction to obtain an ultrafine-milled, whole-grain wheat flour. According to Korolchuk, grinding the coarse fraction in a gap mill to a particle size less than or equal to 500 microns reduces the microbial load. After sifting, any ground coarse fraction having a particle size greater than 500 microns is returned to the process for further milling. Production of a hot cereal product is not disclosed, and use of such a fine particle size whole wheat flour in the production of hot cereal products would result in increased rancidity problems, and a hot cereal having a mushy, pasty texture and mouthfeel.

Japanese Patent Publication No. JP 205168451 A discloses that a wheat flour having a mean particle diameter of 150 to 230 microns and an ash content of 0.8 to 1.2% does not have a grassy-smelling wheat bran smell, is rich in nutritive value and flavor, and can be used in the production of noodles, and confectionery. Heat-treatment of the flour to inactivate enzymes such as lipase and lipoxygenase is not disclosed.

Use of steam or other heat sources to inactivate enzymes such as lipase and lipoxygenase in whole grains is disclosed in U.S. Pat. No. 4,737,371 to Bookwalter, U.S. Pat. No. 5,066,506 to Creighton et al, and U.S. Pat. No. 6,616,957 to Wilhelm et al. Production of hot cereal products is not disclosed.

U.S. Patent Application Publication Nos. US 2003/0087012 A1, US 2003/0082280A1, and U.S. Pat. No. 6,497,909 each to Metzger disclose the bleaching of cereal grain to obtain a bleached whole wheat flour having the color and taste of white flour and which is resistant to enzymatic browning. U.S. Patent Publication No. US 2003/0108652 to Monsalve-Gonzalez et al discloses the production of a bleached bran product which may be admixed with whole wheat flour to produce white whole wheat flour. The bleached products may be used in the production of ready-to-eat cereals, but none of these references disclose production of a hot cereal product.

The present invention provides a process for making stabilized whole grain hot cereal products containing natural proportions of bran, germ, and endosperm, which readily hydrate into creamy, smooth whole grain hot cereals which are at least substantially lump-free. The dry, whole grain hot cereal product of the present invention is produced by milling or grinding of endosperm, bran, and germ to a particle size which is small enough to avoid a gritty, coarse texture, but large enough to avoid a mushy, pasty texture and rancidity problems. Heat treatment of the endosperm, bran and germ reduces insect contamination and achieves a high level of enzyme inactivation, while retaining high levels of essential nutrients, such as antioxidants and vitamins. The present invention provides dry, particulate whole grain cereal products with extended shelf lives that may be heated in the presence of water to form a hot cereal having a course matrix, bound by a fine matrix to create a creamy, smooth texture without lumps. The dry whole grain hot cereal products may be uncooked or only partially cooked for subsequent hydration and cooking on a stove top by the consumer. In other embodiments, the dry whole grain hot cereal products may be an “instant” cereal which is substantially or completely precooked for subsequent heating and hydration by the consumer by the addition of hot water without external heating.

The present invention also provides stabilized whole grain hot cereal products which meet the standard of identity for ingredient labeling proposed by the FDA and AACCI for identifying the ingredient as “whole grain.” As indicated in the U.S. Food and Drug Administration Feb. 15, 2006 draft guidance and as used herein, the term “whole grain” includes cereal grains that consist of the intact, ground, cracked or flaked fruit of the grains whose principal components—the starchy endosperm, germ and bran—are present in the same relative proportions as they exist in the intact grain. This definition is nearly the same as AACC International's definition of “Whole grains shall consist of the intact, ground, cracked or flaked caryopsis, whose principal anatomical components—the starchy endosperm, germ and bran—are present in the same relative proportions as they exist in the intact caryopsis” which was approved in 1999 and is applicable herein. The FDA outlined that such grains may include barley, buckwheat, bulgur, corn, millet, rice, rye, oats, sorghum, wheat and wild rice. Although this invention is exemplified by reference to wheat berries, it will be appreciated that other cereal grains are also contemplated to be within the scope of various or certain aspects of the invention. Examples of other whole grains that may be processed in accordance with various or certain embodiments of this invention include, for example, oats, corn, rice, wild rice, rye, barley, buckwheat, bulgar, millet, sorghum, mixtures thereof, and the like.

### SUMMARY OF THE INVENTION

A dry, whole grain hot cereal product which readily hydrates into a creamy whole grain hot cereal is produced by milling or grinding endosperm, bran and germ to obtain a milled or ground whole grain mixture having a particle size distribution of 100% by weight through a No. 16 (1,190 micron) U.S. Standard Sieve, preferably a No. 18 (1,000 micron) U.S. Standard Sieve, most preferably a No. 20 (841 micron) U.S. Standard Sieve, and less than or equal to about 7% by weight, preferably less than or equal to about 5% by weight, most preferably less than or equal to about 3% by weight through a No. 100 (149 micron) U.S. Standard Sieve. The particle size distribution of the milled whole grain mixture is small enough to avoid production of a whole grain hot cereal with a gritty, coarse texture and appearance, but large enough to avoid a mushy, pasty texture and rancidity problems.

The endosperm, the bran and the germ may be stabilized before or after milling of the endosperm, the bran and the germ. Stabilization to avoid insect infestation and to at least substantially inactivate lipase and lipoxygenase may be achieved by heating the endosperm, the bran and the germ to a temperature of at least about 140° F., preferably at least about 170° F., for example from about 180° F. to about 200° F., or up to about 250° F. Higher stabilization temperatures may generally be employed with an instant product than with a cook-on-stove product because the degree of gelatinization is lower for the cook-on-stove product. Heating times for stabilization may range from about 3 minutes up to about 30 minutes, with lower stabilization temperatures requiring longer heating times. Moisture contents during stabilization for an instant hot cereal product may range from about 7% by weight to about 30% by weight, preferably from about 10% by weight to about 20% by weight, for example from about 14% by weight to about 18% by weight. Moisture contents during stabilization for a cook-on-stove hot cereal product may range from about 7% by weight to about 14% by weight.

In single stream embodiments of the present invention, the milled whole grain mixture may be obtained by milling whole cereal grains to a particle size of 100% by weight through a No. 16 (1,190 micron) U.S. Standard Sieve, preferably a No. 18 (1,000 micron) U.S. Standard Sieve, most preferably a No. 20 (841 micron) U.S. Standard Sieve, and less than or equal to about 7% by weight, preferably less than or equal to about 5% by weight, most preferably less than or equal to about 3% by weight through a No. 100 (149 micron) U.S. Standard Sieve. The milled whole grain mixture may then be heated to at least substantially reduce the lipase activity of the milled whole grain mixture. In other embodiments, the whole cereal grains may be stabilized prior to milling.

In multiple stream embodiments of the present invention, the milled whole grain mixture may be obtained by admixing separate streams or sources of milled endosperm, milled germ and milled bran to provide a milled whole grain mixture having the starchy endosperm, germ and bran present in the same relative proportions as they exist in the intact grain, a particle size distribution of 100% by weight through a No. 16 (1,190 micron) U.S. Standard Sieve, preferably a No. 18 (1,000 micron) U.S. Standard Sieve, most preferably a No. 20 (841 micron) U.S. Standard Sieve, and less than or equal to about 7% by weight, preferably less than or equal to about 5% by weight, most preferably less than or equal to about 3% by weight through a No. 100 (149 micron) U.S. Standard Sieve. The endosperm, germ and bran streams or sources may be stabilized prior to combining with each other or after combining with each other. In preferred embodiments the milled whole grain mixture is obtained by admixing a coarse fraction comprising bran and germ with a fine fraction comprising endosperm. Preferably, the coarse fraction, or separate bran and germ streams, sources, or fractions are stabilized prior to admixing with the fine fraction by heating to at least substantially reduce the lipase activity.

The dry, whole grain hot cereal product produced in accordance with the present invention may be a cook-on-stove or stove top hot cereal product, or an instant hot cereal product. The two types of products are each a stabilized whole grain particulate mixture, but they differ in their degrees of starch gelatinization and the amount and type of heating, or cooking needed to be performed by the consumer to prepare the final whole grain hot cereal. In the cook-on-stove or stove top hot cereal product, the starch is substantially non-gelatinized and generally longer cook times and external heating are needed by the consumer. In the instant hot cereal product, the starch is at least substantially or completely gelatinized and little if any cooking or application of external heat is needed by the consumer.

In the preparation of the stove top whole grain hot cereal product, heating or stabilization may result in a degree of gelatinization of starch contained in the stabilized whole grain particulate mixture of less than about 10% as measured by differential scanning calorimetry (DSC), and the stabilized whole grain particulate mixture is hydratable by admixing the particulate mixture with water and applying external heat to cook the particulate mixture into a creamy whole grain hot cereal which is at least substantially lump-free.

In the preparation of the instant whole grain hot cereal product the milled whole grain mixture may be admixed with water and the heating or stabilization may include cooking which results in a degree of gelatinization of starch contained in the stabilized whole grain particulate mixture of at least about 70%, preferably at least about 90%, more preferably about 100% as measured by differential scanning calorimetry (DSC). In embodiments of the invention, the milled whole grain mixture may be cooked in the presence of disodium phosphate and an enzyme to reduce cooking time. The heating, stabilization, or cooking may include pressure cooking of the milled whole grain mixture at a temperature of about 230° F. (110° C.) to about 248° F. (120° C.), at a pressure of about 10 psig to about 15 psig, for about 10 minutes to about 30 minutes. The cooked, stabilized whole grain particulate mixture may be ground, then flaked. Drying may precede and/or follow flaking, but preferably is performed before flaking. The dried, flaked, stabilized whole grain particulate mixture is hydratable into a creamy whole grain hot cereal which is at least substantially lump-free by admixing the flaked, particulate mixture with hot water without the need to apply external heat to cook the particulate mixture.

### DETAILED DESCRIPTION OF THE INVENTION

The present invention provides a stabilized, dry whole grain hot cereal product, such as a stabilized, whole wheat hot cereal product, and processes for making the stabilized dry, whole grain hot cereal product. The dry, whole grain hot cereal product may be a cook-on-stove or stove top hot cereal product or an instant hot cereal product, and readily hydrates into a course matrix, bound by a fine matrix to create a creamy whole grain hot cereal. The dry, whole grain hot cereal product may include a stabilized, milled or ground whole grain particulate mixture of endosperm, bran, and germ in the same or substantially the same relative proportions as they exist in the intact grain. The stabilized whole grain particulate mixture is readily hydratable by heating in the presence of water into a creamy, smooth textured whole grain hot cereal which is at least substantially lump-free. The stabilized whole grain particulate mixture is made from a milled or ground whole grain mixture having a particle size distribution which is fine enough to avoid a gritty, coarse texture and appearance, but not so fine as to result in a mushy, pasty texture and large lumps, and rancidity in the hot cereal. The endosperm, the bran and the germ are heated to at least substantially reduce the lipase activity of the milled or ground whole grain mixture, and stabilize it against rancidity and insect infestation.

### Production of the Milled Whole Grain Particulate Mixture

The milled or ground whole grain particulate mixture may be obtained by a one stream or multi-stream process. In the one stream process, the milled endosperm, bran and germ may be derived from the same intact whole grains. In the multi-stream process, the milled endosperm, bran, and germ may be derived from different sources or different intact whole grains and combined so that the milled endosperm, bran, and germ are in the same or substantially the same relative proportions as they exist in the intact grain.

No matter how obtained, the milled whole grain particulate mixture should have a particle size distribution of 100% by weight through a No. 16 (1,190 micron) U.S. Standard Sieve, preferably a No. 18 (1,000 micron) U.S. Standard Sieve, most preferably a No. 20 (841 micron) U.S. Standard Sieve, and less than or equal to about 7% by weight, preferably less than or equal to about 5% by weight, most preferably less than or equal to about 3% by weight through a No. 100 (149 micron) U.S. Standard Sieve. Use of this particle size distribution for the milled whole grain particulate mixture achieves a creamy, smooth texture without lumps and without rancidity problems in the hydrated hot cereal. Use of larger sizes tends to result in a gritty, coarser texture and appearance. Use of smaller particle sizes tends to increase rancidity problems and result in a mushy, pasty, texture and lumping problems in the hydrated hot cereal.

In embodiments of the invention for making a stabilized whole grain hot cereal product, whole cereal grains or berries may be comminuted, ground or milled in conventional manner using known flour milling equipment to obtain ground whole cereal grains. The whole cereal grains may be tempered or untempered, but are preferably untempered, raw whole cereal grains, which have been cleaned. Moisture contents of from about 11% by weight to about 14.5% by weight are preferred for milling or grinding purposes, with moisture contents of about 12.5% by weight to about 13.5% by weight being particularly preferred. If there is too little moisture in the grains or berries, the grains or berries may undesirably shatter and create damaged starch. Too high an amount of moisture may render the grains or berries susceptible to excessive starch gelatinization and may also cause the grains or berries to be difficult to mill or grind. For these reasons, grain or berry moisture contents of from about 11% by weight to about 14.5% by weight are preferred just prior to milling or grinding. If the moisture content of the grains or berries is too low, moisture may be added to the dry grains or berries prior to milling or grinding to increase the moisture content to an acceptable level for milling or grinding. Moisture addition may be achieved in a conventional manner by tempering the grains or berries or spraying their surfaces with water and permitting them to soak. Natural whole grains such as wheat berries generally have a moisture content of from about 10% by weight to about 14.5% by weight. Accordingly, in preferred embodiments of the invention, moistening or tempering of the whole berries or grains or moistening of the coarse fraction to achieve a desired moisture content for milling or grinding may not be needed or employed. Where tempering is employed, conventional tempering techniques and equipment may be employed. For example, the tempering and agitation can be done in a ribbon blender or a mixer. The tempering is usually done at a temperature of about 30° C. to about 40° C. for about 5 minutes to about 60 minutes and preferably at a temperature of about 32° C. for about 15 minutes to about 30 minutes. The tempering can be done at, below or above atmospheric pressure. The tempering reduces the time required for the subsequent cooking step. The temperature and time of the tempering step generally do not allow setting or substantial gelatinizing of the starch present in the admixture components.

In embodiments of the invention, the comminuted, ground, or milled whole cereal grains may be subjected to conventional separating or screening operations, using known grain processing equipment to obtain a coarse fraction and a fine fraction. The coarse fraction is enriched in bran and germ and may also contain endosperm, and the fine fraction is predominately endosperm, and may also contain some bran and germ.

Whole grains contain primarily the endosperm, bran, and germ, in diminishing proportions, respectively. In whole wheat grains, for example, at field moisture of about 13% by weight, the endosperm or starch is about 83% by weight, the bran is about 14.5% by weight, and the germ is about 2.5% by weight, based upon the weight of the intact grain. The endosperm contains the starch, and is lower in protein content than the germ and the bran. It is also low in crude fat and ash constituents.

The bran (pericarp or hull) is the mature ovary wall which is beneath the cuticle, and comprises all the outer cell layers down to the seed coat. It is high in non-starch-polysaccharides, such as cellulose and pentosans. A pentosan is a complex carbohydrate present in many plant tissues, particularly brans, characterized by hydrolysis to give five-carbon-atom monosaccharides (pentoses). It is any member of a group of pentose polysaccharides having the formula (C₅H₈O₄)ₙ found in various foods and plant juices. The bran or pericarp tends to be very tough due to its high fiber content and imparts a dry, gritty mouthfeel, particularly when present in large particle sizes. It also contains most of the lipase and lipoxygenase of the grain and needs to be stabilized.

In embodiments of the grain milling process, the production of the coarse fraction and the fine fraction can include conducting a quantity of whole grains, such as wheat, through at least one set of break rolls or rollermills, and a sifter downstream of each set of break rolls to provide milled grains. As more break rolls are employed more starch or endosperm is released, and the bran tends to remain in larger, coarser particles than the endosperm. During the breaking operation the bran particles tend to flatten while the endosperm tends to fragment into individual starch granules. The milled grains may be sifted or purified to collect the fine fraction and retain the coarse fraction. For example, in embodiments of the invention, wheat berries may be conducted through at least one set of break rolls and their sifters to: 1) collect a first endosperm fraction and retain a first ground coarse fraction, 2) grind the retained first ground coarse fraction to collect a second endosperm fraction, 3) combine the first endosperm fraction and the second endosperm fraction to obtain a fine fraction with a particle size distribution within the desired range, and 4) retain a second ground coarse fraction for further size reduction to obtain a particle size distribution within the desired range, so that upon combining the coarse fraction and the fine fraction, the resulting milled whole grain particulate mixture has a particle size distribution within the desired range, and the milled endosperm, bran, and germ are in the same or substantially the same relative proportions as they exist in the intact grain. In conventional milling operations, five sets of break rolls and a sifter downstream of each set of break rolls may be employed.

In embodiments of the invention, the milled endosperm, bran, and germ may be obtained from separate sources and then combined to obtain the milled whole grain particulate mixture. For example, commercially available bran or germ or mixtures thereof may be combined with commercially available endosperm or farina or wheat middlings. The commercially available bran, germ, or mixtures thereof and the commercially available endosperm, farina, or wheat middlings may be milled to the desired particle size range either before or after combining them to obtain the milled whole grain particulate mixture.

The different grain fractions, such as a stabilized bran fraction which comprises a ground or milled, heat-treated coarse fraction comprising bran, germ and starch, and an optionally stabilized endosperm fraction, may be blended, combined, or admixed using conventional metering and blending apparatus known in the art to obtain an at least substantially homogeneous milled whole grain particulate mixture. Exemplary of mixing or blending devices which may be employed include batch mixers, rotating drums, continuous mixers, and extruders.

### Stabilization of the Milled Whole Grain Particulate Mixture

Stabilization of the milled whole grain particulate mixture by heating to prevent insect infestation and to inactivate lipase and lipoxygenase may be performed before, during, or after the grinding or milling of either: 1) the whole grain, 2) individual or separate endosperm, bran, and germ fractions, or 3) combinations of endosperm, bran, and germ fractions, such as a coarse fraction comprising bran and germ. In embodiments of the invention, stabilization may be by any combination of heating before, during and after grinding and milling. The stabilization is preferably performed after grinding or milling of the coarse fraction. In embodiments of the invention commercially available stabilized milled whole grains or commercially available stabilized grain fractions, such as stabilized bran and germ fractions, and commercially available stabilized endosperm fractions or farina or wheat middlings may be employed. The stabilization may be conducted separately from and in addition to any cooking step, or it may be a part of the cooking step, such as in the precooking or pressure cooking of the milled whole grains in the preparation of an instant hot cereal product. In embodiments of the invention, the stabilization of the endosperm or farina, or wheat middlings may be separate from stabilization of the bran and germ and may just involve heat treatment for reducing or preventing insect infestation, because the lipase and lipoxygenase enzymes may not be present in a substantial amount.

Irrespective of when it is conducted, stabilization of the whole grain or grain fractions, such as a coarse fraction comprising bran and germ, may be achieved by heating under temperature conditions, moisture content, and treatment times which are sufficient to at least substantially inactivate the lipase, and the more easily inactivated lipoxygenase.

The moisture content of the whole grain or grain fraction during stabilization should not be so high so as to result in excessive starch gelatinization or to require extensive drying to achieve a shelf stable moisture content. In embodiments of the invention, for producing an instant hot cereal product, the moisture content of the whole grain or grain fraction subjected to the stabilization may be from about 7% by weight to about 30% by weight, preferably from about 10% by weight to about 20% by weight, for example from about 14% by weight to about 18% by weight. In producing a cook-on-stove hot cereal product, the moisture content of the whole grain or grain fraction subjected to the stabilization may be from about 7% by weight to about 14% by weight. During the stabilization it is generally preferred that the whole grain or grain fraction neither gain nor lose moisture substantial amounts of water. Moisture loss and moisture gain may be controlled in a known manner so that the moisture content during stabilization is within the desired range for controlling gelatinization, and drying requirements, and lipase activity. In embodiments of the invention, a desired moisture content for stabilization or cooking may be achieved by spraying and admixing the milled whole grain particulate mixture or one or more grain fractions with water and tempering. For example, the tempering and agitation can be done in a ribbon blender or a mixer. The tempering may be performed at a temperature of about 30° C. to about 40° C. for about 5 minutes to about 60 minutes and preferably at a temperature of about 32° C. for about 15 minutes to about 30 minutes. The tempering can be done at, below or above atmospheric pressure.

Stabilization to avoid insect infestation and to at least substantially inactivate lipase and lipoxygenase may be achieved by heating the endosperm, the bran and the germ to a temperature of at least about 140° F., preferably at least about 170° F. Higher stabilization temperatures may generally be employed with an instant product than with a cook-on-stove product because the degree of gelatinization is lower for the cook-on-stove product. For example, in embodiments of the invention, stabilization temperatures employed in the production of an instant hot cereal product may range from about 180° F. to about 220° F. or higher, such as up to about 250° F. or temperatures employed during pressure cooking. Exemplary stabilization temperatures employed in the production of a cook-on-stove hot cereal product may range from about 180° F. to about 200° F. Heating times for stabilization may range from about 3 minutes up to about 30 minutes, with lower stabilization temperatures requiring longer heating times. In embodiments of the invention, heating of the endosperm fraction or the farina or wheat middlings may be under conditions which differ from those employed for stabilization of the bran and germ. For example, lower temperatures, sufficient to prevent insect infestation may be employed for stabilization of the endosperm fraction, and higher temperatures sufficient to inactivate lipase and lipoxygenase may be employed for stabilization of a course fraction comprising bran and germ.

In the preparation of the stove top whole grain hot cereal product, heating or stabilization may result in a degree of gelatinization of starch contained in the stabilized whole grain particulate mixture of less than about 10% as measured by differential scanning calorimetry (DSC). In the preparation of the instant whole grain hot cereal product the milled whole grain mixture may be admixed with water and the heating or stabilization may include cooking which results in a degree of gelatinization of starch contained in the stabilized whole grain particulate mixture of at least about 70%, preferably at least about 90%, more preferably about 100% as measured by differential scanning calorimetry (DSC). Generally, starch gelatinization occurs when: a) water in a sufficient amount, generally at least about 30% by weight, based upon the weight of the starch, is added to and mixed with starch and, b) the temperature of the starch is raised to at least about 80° C. (176° F.), preferably 100° C. (212° F.) or more. The gelatinization temperature depends upon the amount of water available for interaction with the starch. The lower the amount of available water, generally, the higher the gelatinization temperature. Gelatinization may be defined as the collapse (disruption) of molecular orders within the starch granule, manifested in irreversible changes in properties such as granular swelling, native crystallite melting, loss of birefringence, and starch solubilization. The temperature of the initial stage of gelatinization and the temperature range over which it occurs are governed by starch concentration, method of observation, granule type, and heterogeneities within the granule population under observation. Pasting is the second-stage phenomenon following the first stage of gelatinization in the dissolution of starch. It involves increased granular swelling, exudation of molecular components (i.e., amylose, followed by amylopectin) from the granule, and eventually, total disruption of the granules. See Atwell et al., “The Terminology And Methodology Associated With Basic Starch Phenomena,” Cereal Foods World, Vol. 33, No. 3, pgs. 306-311 (March 1988).

Heating or stabilization may be performed on a batch, semi-batch or continuous basis, with the latter being preferred. Known heating vessels, such as batch cookers, mixers, heat exchangers, rotating drums, continuous mixers, and extruders may be employed for heating the whole grains or grain fraction to stabilize it. The heating apparatus may be jacketed vessels equipped with heating or cooling jackets for external control of the stabilization temperature and/or steam injection nozzles for direct injection of moisture and heat into the coarse fraction. In other embodiments, infrared (IR) radiation or energy may be employed to heat the whole grain or grain fraction to stabilize it. In a preferred embodiment, heating or stabilization may be performed in a Komline-Sanderson Nara Paddle Dryer/Processor, which is a highly efficient, mechanically agitated, indirect heat transfer device for putting heat into or removing heat from a process mass. The heat transfer medium, steam, oil, thermal fluid, water, or glycol is isolated from the process mass. Dual counter-rotating shafts with intermeshing wedge shape paddles produce intimate mixing and optimize heat transfer. The use of hollow paddles for heat transfer results in a compact machine. In another embodiment, a Bethlehem Porcupine® processor may be employed for heating or stabilization of the whole grains or grain fractions.

In embodiments of the invention for the preparation of an instant whole grain hot cereal product, the heating or stabilization may include cooking to at least substantially or completely gelatinize the starch of the milled whole grain mixture. The heating, stabilization, or cooking may include pressure cooking of the milled whole grain mixture, whether previously stabilized or not, at a temperature of about 230° F. (110° C.) to about 248° F. (120° C.), at a pressure of about 10 psig to about 15 psig, for about 10 minutes to about 30 minutes, at about the same moisture content employed for stabilization, e.g., from about 7% by weight to about 30% by weight. During cooking by steam injection, the moisture content may increase by up to about 20% due to steam condensation and water absorption by the milled whole grain mixture. In embodiments of the invention, the milled whole grain mixture may be cooked in the presence of disodium phosphate and an enzyme, such as alpha amylase, in conventional amounts to reduce cooking time. The cooking can be done using any suitable steam pressure cooker or a continuous or batch heat exchanger. The cooking step may involve a heat treatment which causes a loss of birefringence but is not so severe as to produce transparency of the endosperm particles. The cooking step may be accomplished using a rotating drum which is internally heated or using a simple retort, a Komline-Sanderson Nara Paddle Dryer/Processor, a Bethlehem Porcupine® processor, and the like. Exposure therein is preferably of sufficient temperature-time contact so as to completely cook the product. The cooking should completely gelatinize the starch present in the composition. The cooked material may be composed of particles which have increased to an average particle size of No. 12 (1,680 micron) U.S. Standard Sieve to No. 60 (250 micron) U.S. Standard Sieve or larger.

A particle size reduction step may be employed on the heated, stabilized, or cooked whole grain particulate mixture to eliminate lumps and large agglomerates, which may reach sizes of up to about 4 inches. The preferred particle size reduction technique is grinding, although the particle size reduction can be done using any suitable particle size reduction technique and equipment. The particle size of the cooked material may be reduced to less than about 0.5 inches by the grinders, lump breaker, sifter, or sizer. For example, the cooked product may be passed through a grinder with an inserted screen designed for the reduction of the size of the particles of cooked material. The particle size of the heated, stabilized, or cooked material may, for example, be reduced to less than about ⅛ inch with a ⅛ inch mesh screen or sifter.

The ground, cooked whole grain particulate mixture may be flaked using any suitable flaking equipment and method. Flaking is basically a process or step of flattening the optionally tempered, cooked grain particles between rollers. For example, the ground, cooked whole grain particulate mixture can be flaked by passing it between large steel cylinders (rotating at, for example, 180 to 200 revolutions per minute, or higher), with the rolls cooled by internal water circulation to avoid sticking, particularly at the high water content of the material to be flaked. Generally, screw conveyors or drag chain conveyors may be used to transport the cooked grain material to the flaking rolls. In preferred embodiments of the invention, the cooked grain material may be dried before flaking in a conventional manner to a moisture content which does not result in deleterious sticking of the flakes to the flaking rolls. When drying is performed before flaking, the cooked particulate material may be dried to a moisture content of preferably less than or equal to about 14% by weight, preferably about 12% by weight to about 13% by weight, based upon the total weight of the dried, stabilized, cooked whole grain particulate mixture. The drying can be done using any conventional drying technique and equipment. Exemplary drying temperatures may range from about 185° F. (85° C.) to about 250° F. (121° C.), and drying times may range from about 5 minutes to about 10 minutes. Just before falling into the large steel flaking rolls, the cooked grain material may be tempered at about 90° F. to about 100° F., and the grain particles become plasticized. The temperature of the grain particles during the flaking step is preferably not allowed to rise above about 120° F. The pressure applied to the grain material increases their diameter several times and decreases their thickness proportionately. In embodiments where drying does not precede flaking, when the flaked grain particles leave the rolls, the flakes may contain about 15 to about 20 percent of moisture and are still flexible. The wet flakes, before drying, are flexible and may have a thickness of about 0.010 inches to about 0.020 inches, for example about 0.015 inches.

In embodiments where drying precedes or does not precede flaking, the flaked, stabilized, cooked whole grain particulate mixture may be dried to a shelf stable moisture content. Also, in the case of the stove top product, the stabilized whole grain particulate mixture which has not been fully cooked or flaked, may be dried to a shelf stable moisture content. For either product, the particulate material may be dried to a shelf stable moisture content of less than or equal to about 14% by weight, preferably about 12% by weight to about 13% by weight, based upon the total weight of the dried, stabilized, whole grain particulate mixture. The drying can be done using any conventional drying technique and equipment. Exemplary drying or heating temperatures for the cook-on-stove product may range from about 158° F. (70° C.) to about 185° F. (85° C.), and drying or heating times may range from about 5 minutes to about 12 minutes. Exemplary drying temperatures for the instant product may range from about 185° F. (85° C.) to about 250° F. (121° C.), and drying times may range from about 5 minutes to about 10 minutes.

After drying the stabilized whole grain particulate mixture, the dry mixture may be admixed with conventional amounts of fortifying and other additives, such as flavoring, colorant, salt, sugars, minerals, wheat germ, cocoa, gums, fruit pieces, antioxidants and the like to obtain a substantially homogenous dry, whole grain cereal product in accordance with the present invention. The additives include B-complex vitamins, malt, soluble iron compounds, vitamin A, vitamin C, BHA and BHT. Also, non-fat dry milk solids, (i.e., milk powder) or soybean protein may be added in an amount sufficient to create a final protein level of up to about 10% by weight to about 20% by weight. Exemplary total amounts of the fortifying and other additives may range up to about 35% by weight, for example from about 5% by weight to about 30% by weight, based upon the weight of the dried, stabilized whole grain particulate mixture.

In embodiments of the invention, the amount of at least one fruit which may be incorporated into the dried, stabilized whole grain particulate mixture, such as flaked wheat material, may range from about 5% by weight to about 10% by weight, based upon the weight of the dried, stabilized whole grain particulate mixture. Exemplary dried fruits that can be used in the present invention include dried apple, apricot, blackberry, boysenberry, cherry, currant, plum, elderberry, fig, gooseberry, grape, guava, loganberry, nectarine, peach, pear, pineapple, quince, raspberry, strawberry, and mixtures thereof.

Optional gums which may be employed in conventional amounts, such as from about 0.5% by weight to about 5% by weight, based upon the weight of the dried, stabilized whole grain particulate mixture, include guar gum, alginates, such as sodium alginate, arabic gum, carrageenan, and xanthan gum. The optional gums may help increase the viscosity in the rehydrated product.

Salt, generally sodium chloride, may be employed in an amount of about 0.5% to about 4.0% by weight, based upon the weight of the dried, stabilized whole grain particulate mixture. In embodiments of the invention, potassium chloride may be used to replace a part or all of the sodium chloride.

The dry, whole grain cereal product in accordance with the present invention may have a moisture content of less than or equal to about 14% by weight, preferably about 12% by weight to about 13% by weight, based upon the total weight of the dry, whole grain cereal product. The dry, whole grain cereal product is quite stable, with a water activity of less than about 0.7, and may be stored in a sealed container for at least 12 months.

The dry, whole grain cereal products of the present invention can be made ready-to-eat or prepared for consumption by reconstituting or rehydrating with hot water, milk or other suitable edible liquid containing water. Usually hot milk or hot water is used for reconstitution. Sugar or other sweeteners, for example, can be added.

The dried, flaked product is in a ready-to-eat or instant form and is truly an “instant” hot cereal such as an instant wheat farina-like product which can be prepared in a bowl by the consumer without a cooking step or the application of external heat, by admixing with hot water or milk, e.g., boiling or near boiling water to obtain a creamy whole grain hot cereal which is at least substantially lump-free. While not necessary, the instant product can be reconstituted by cooking (boiling) for a minute or so. It is not necessary to have added disodium phosphate (e.g., 0.25 weight percent), although it can be used, to reduce the cooking time since reconstitution by cooking is only an option.

The stove top or non-flaked product is rehydrated or prepared for consumption by admixing the particulate mixture with water or a source of water, such as milk, and applying external heat, for example on a stove top, to cook the particulate mixture into a creamy whole grain hot cereal which is at least substantially lump-free. The cooking time for preparing the stove top product may range from about 0.5 minutes to about 10 minutes. Disodium phosphate may be included in the composition (e.g., 0.25 weight percent to 0.8 weight percent) to reduce the cooking time.

The present invention is applicable to any and all types of wheat. Although not limited thereto, the wheat berries may be selected from soft/soft and soft/hard wheat berries. They may comprise white or red wheat berries, hard wheat berries, soft wheat berries, winter wheat berries, spring wheat berries, durum wheat berries, or combinations thereof. Generally hard wheat is preferred to avoid pastiness upon cooking. Examples of other whole grains that may be processed in accordance with various or certain embodiments or aspects of this invention include, for example, oats, corn, rice, wild rice, rye, barley, buckwheat, bulgar, millet, sorghum, and the like, and mixtures of whole grains.

In other embodiments of the invention, the dry, stabilized whole grain particulate mixture or the whole grain hot cereal product may be combined, admixed, or blended with farina or non-whole grain hot cereal products (such as an instant Cream of Wheat® cereal product) to obtain a dry, stabilized particulate mixture or hot cereal product which is fortified with a whole grain ingredient or product. The fortified product may contain the whole grain ingredient or product in an amount of from about 15% by weight to about 40% by weight, for example from about 20% by weight to about 30% by weight, based upon the total weight of the fortified product.

The present invention is illustrated by the following non-limiting examples wherein all parts, percentages, and ratios are by weight, all temperatures are in ° C., and all temperatures are atmospheric, unless indicated to the contrary:

### EXAMPLE 1

An instant whole wheat hot cereal product may be produced by first cleaning whole wheat berries, and conveying the cleaned berries to a milling operation where the whole berries may be milled or ground to obtain a milled whole wheat particulate mixture with a particle size distribution of 100% by weight through a No. 20 (841 micron) U.S. Standard Sieve, and less than or equal to about 7% by weight through a No. 100 (149 micron) U.S. Standard Sieve. The milled whole wheat particulate mixture may be conveyed to a ribbon mixer where water may be sprayed onto the milled whole wheat particulate mixture with mixing to wet the wheat particles and to achieve a moisture content of about 30% by weight. The wetted wheat particles may be tempered with agitation for about 5 minutes at a temperature of about 35° C. The tempered material may be cooked in a pressure cooker for about 15 minutes at about 13 psig, with the cooking time being measured from the time of steam introduction.

After the cooking period, the cooker may be emptied to obtain a stabilized, cooked particulate mixture having a moisture content of about 32% by weight to about 34% by weight. The cooked composition may be dumped onto a cooling conveyor, subjected to limiting rotors and conveyed on a cooling conveyor to a first lump breaker (used to reduce the large lumps). The cooked product may then be conveyed on a cooling conveyor to a second lump breaker and then conveyed to two grinders. Further cooling, if necessary, may be performed using cooling reels before treatment in the grinders. A ⅛ inch mesh screen may be used in each grinder. The conveyor used to convey the cooled wheat material into the grinders may be a cooling and load-leveling belt conveyor which regulates the flow of material. The ground or milled material may be dried in a dryer at a temperature of about 200° F. to a moisture content of about 12% by weight to about 14% by weight. The dried material may be tempered for about 30 minutes, then fed into a surge hopper, and then conveyed to a feeder for a flaker. Cold water-cooled flaking rolls may be used to flake the cooked material. The flaked material may have a moisture content of about 12% by weight to about 14% by weight. The flaked composition may then be thoroughly admixed with a fortification mixture in a blender to produce a finished product having a composition with relative amounts by weight of ingredients as shown in Table 1:

TABLE 1
Composition of Instant Whole Grain Cereal Product

| | |
|---|---|
| Dried, Stabilized, Flaked, Whole Wheat Particulate Mixture | 100.0 |
| Dough Salt | 2.0 |
| Fully Fortified Wheat Germ including iron, calcium, | 2.5 |
| Vitamin B1, Vitamin B2 and Niacin | |
| Guar Gum | 2.0 |
| Fine Grain Sugar Plus Antioxidant | 16.0 |

The blended product may be conveyed by a conveyor to a packaging machine where it may be packed in individual serving portions at 1 oz. per packet. Ten (10) packets may be packed per carton. The dry whole wheat hot cereal product containing a stabilized, milled whole wheat particulate mixture comprising endosperm, bran, and germ in the same or substantially the same relative proportions as they exist in the intact grain, may be readily reconstituted in a bowl by the addition of hot water to produce a whole grain hot breakfast cereal product which is very appetizing in appearance, odor and taste, and a creamy and smooth texture with at least substantially no lumps.

### EXAMPLE 2

An instant whole wheat hot cereal product may be produced as in Example 1 except a milled whole wheat particulate mixture with a particle size distribution of 100% by weight through a No. 16 (1,190 micron) U.S. Standard Sieve, and less than or equal to about 5% by weight through a No. 100 (149 micron) U.S. Standard Sieve may be obtained by admixing separate sources of a fine fraction comprising endosperm, and a course fraction comprising bran and germ. The coarse fraction and the fine fraction may be admixed in relative amounts to provide an admixture of endosperm, bran, and germ in the same or substantially the same relative proportions as they exist in the intact grain. Prior to being mixed together: 1) the coarse fraction may have a particle size distribution of 100% by weight through a No. 16 (1,190 micron) U.S. Standard Sieve, and less than or equal to about 5% by weight through a No. 100 (149 micron) U.S. Standard Sieve, and 2) the fine fraction may have a particle size distribution of 100% by weight through a No. 20 (841 micron) U.S. Standard Sieve, and less than or equal to about 5% by weight through a No. 100 (149 micron) U.S. Standard Sieve. In addition, the coarse fraction may be stabilized prior to admixing with the fine fraction by heating the coarse fraction to a temperature of from about 180° F. to about 220° F. to at least substantially reduce the lipase activity of the coarse fraction.

### EXAMPLE 3

An instant whole wheat hot cereal product may be produced as in Example 1 except a milled whole wheat particulate mixture with a particle size distribution of 100% by weight through a No. 16 (1,190 micron) U.S. Standard Sieve, and less than or equal to about 5% by weight through a No. 100 (149 micron) U.S. Standard Sieve may be obtained by admixing separate sources of a fine fraction comprising endosperm, and a commercially available stabilized course fraction or bran component comprising bran and germ. The coarse fraction and the fine fraction may be admixed in relative amounts to provide an admixture of endosperm, bran, and germ in the same or substantially the same relative proportions as they exist in the intact grain. Prior to being mixed together: 1) the coarse fraction may have a particle size distribution of 100% by weight through a No. 16 (1,190 micron) U.S. Standard Sieve, and less than or equal to about 5% by weight through a No. 100 (149 micron) U.S. Standard Sieve, and 2) the fine fraction may have a particle size distribution of 100% by weight through a No. 20 (841 micron) U.S. Standard Sieve, and less than or equal to about 5% by weight through a No. 100 (149 micron) U.S. Standard Sieve.

### EXAMPLE 4

A stove top whole wheat hot cereal product may be produced by first cleaning whole wheat berries, and conveying the cleaned berries to a milling operation where the whole berries may be milled to obtain a milled whole wheat particulate mixture with a particle size distribution of 100% by weight through a No. 20 (841 micron) U.S. Standard Sieve, and less than or equal to about 5% by weight through a No. 100 (149 micron) U.S. Standard Sieve. The milled whole wheat particulate mixture may be conveyed to a continuous mixer and admixed with conventional fortifying amounts of vitamins and minerals and disodium phosphate to obtain a homogeneous mixture which may then be heated in a Komline-Sanderson Nara Paddle Dryer/Processor at a temperature of from about 170° F. to about 190° F. to at least substantially reduce the lipase activity of the milled whole grain mixture, while keeping the degree of starch gelatinization of starch contained in the stabilized whole grain particulate mixture less than about 10% as measured by differential scanning calorimetry (DSC).

After the heat stabilization period, the processor may be emptied to obtain a stabilized, particulate mixture having a moisture content of about 12% by weight. The stabilized composition may be passed through a sifter with a No. 16 (1,190 micron) U.S. Standard Sieve to eliminate large lumps, and then conveyed to packaging.

The sifted, stabilized particulate mixture may be conveyed by a conveyor to a packaging machine where it may be packed in bulk packages. The dry whole wheat hot cereal product containing a stabilized, milled whole wheat particulate mixture comprising endosperm, bran, and germ in the same or substantially the same relative proportions as they exist in the intact grain, may be readily reconstituted in a pot by the addition of hot water, and cooking the admixture on a stove top for about 0.5 minutes to about 10 minutes, with occasional stirring to produce a whole grain hot breakfast cereal product which is very appetizing in appearance, odor and taste, and a creamy and smooth texture with at least substantially no lumps.

### EXAMPLE 5

A stove top whole wheat hot cereal product may be produced as in Example 4 except a milled whole wheat particulate mixture with a particle size distribution of 100% by weight through a No. 16 (1,190 micron) U.S. Standard Sieve, and less than or equal to about 5% by weight through a No. 100 (149 micron) U.S. Standard Sieve may be obtained by admixing separate sources of a fine fraction comprising endosperm, and a course fraction comprising bran and germ. The coarse fraction and the fine fraction may be admixed in relative amounts to provide an admixture of endosperm, bran, and germ in the same or substantially the same relative proportions as they exist in the intact grain. Prior to being mixed together: 1) the coarse fraction may have a particle size distribution of 100% by weight through a No. 16 (1,190 micron) U.S. Standard Sieve, and less than or equal to about 5% by weight through a No. 100 (149 micron) U.S. Standard Sieve, and 2) the fine fraction may have a particle size distribution of 100% by weight through a No. 20 (841 micron) U.S. Standard Sieve, and less than or equal to about 5% by weight through a No. 100 (149 micron) U.S. Standard Sieve.

### EXAMPLE 6

A stove top whole wheat hot cereal product may be produced as in Example 4 except a milled whole wheat particulate mixture with a particle size distribution of 100% by weight through a No. 16 (1,190 micron) U.S. Standard Sieve, and less than or equal to about 5% by weight through a No. 100 (149 micron) U.S. Standard Sieve may be obtained by admixing separate sources of a fine fraction comprising endosperm, and a commercially available stabilized course fraction or bran component comprising bran and germ. The coarse fraction and the fine fraction may be admixed in relative amounts to provide an admixture of endosperm, bran, and germ in the same or substantially the same relative proportions as they exist in the intact grain. Prior to being mixed together: 1) the coarse fraction may have a particle size distribution of 100% by weight through a No. 16 (1,190 micron) U.S. Standard Sieve, and less than or equal to about 5% by weight through a No. 100 (149 micron) U.S. Standard Sieve, and 2) the fine fraction may have a particle size distribution of 100% by weight through a No. 20 (841 micron) U.S. Standard Sieve, and less than or equal to about 5% by weight through a No. 100 (149 micron) U.S. Standard Sieve.

### EXAMPLE 7

An instant whole wheat hot cereal product may be produced as in Example 1 except dried apple flakes may be admixed with the blend of the flaked whole wheat particulate mixture and the fortification mixture to obtain a finished product having a composition with relative amounts by weight of ingredients as shown in Table 2:

TABLE 2
Composition of Instant Whole Grain Cereal Product With Dried Fruit

| | |
|---|---|
| Dried, Stabilized, Flaked, Whole Wheat Particulate Mixture | 100.0 |
| Dough Salt | 2.0 |
| Fully Fortified Wheat Germ including iron, calcium, | 2.5 |
| Vitamin B1, Vitamin B2 and Niacin | |
| Guar Gum | 2.0 |
| Fine Grain Sugar Plus Antioxidant | 16.0 |
| Dried Apple Flakes | 16.7 |

The finished product may have about 12% by weight of dried fruit, based upon the total weight of the finished product.

What is claimed is:

1. A method for making a dry, whole grain hot cereal product which readily hydrates into a creamy whole grain hot cereal comprising forming a stabilized, milled whole grain particulate mixture comprising endosperm, bran, and germ wherein the endosperm, the bran and the germ have been milled to obtain a milled whole grain mixture having a particle size distribution of 100% by weight through a No. 16 (1,190 micron) U.S. Standard Sieve, and less than or equal to about 7% by weight through a No. 100 (149 micron) U.S. Standard Sieve, and the endosperm, the bran and the germ have been heated to a temperature of at least about 140° F., the stabilized whole grain particulate mixture being readily hydratable by heating in the presence of water into a creamy whole grain hot cereal which is at least substantially lump-free.

2. A method for making a dry, whole grain hot cereal product as claimed in claim 1 wherein the milled whole grain mixture is obtained by milling whole cereal grains to a particle size of 100% by weight through a No. 16 (1,190 micron) U.S. Standard Sieve, and less than or equal to about 7% by weight through a No. 100 (149 micron) U.S. Standard Sieve, and the milled whole grain mixture is heated to a temperature of at least about 170° F. to at least substantially reduce the lipase activity of the milled whole grain mixture.

3. A method for making a dry, whole grain hot cereal product as claimed in claim 1 wherein the milled whole grain mixture is obtained by admixing a coarse fraction comprising bran and germ with a fine fraction comprising endosperm.

4. A method for making a dry, whole grain hot cereal product as claimed in claim 1 wherein the milled whole grain mixture is obtained by admixing a coarse fraction comprising bran and germ with a fine fraction comprising endosperm, and the milled whole grain mixture is heated to a temperature of at least about 170° F. to at least substantially reduce the lipase activity of the milled whole grain mixture.

5. A method for making a dry, whole grain hot cereal product as claimed in claim 1 wherein the milled whole grain mixture is obtained by admixing a coarse fraction comprising bran and germ with a fine fraction comprising endosperm, wherein said coarse fraction has been stabilized prior to admixing with the fine fraction by heating the coarse fraction to a temperature of at least about 170° F. to at least substantially reduce the lipase activity of the coarse fraction.

6. A method for making a dry, whole grain hot cereal product as claimed in claim 1 wherein the bran and germ have been heated to a temperature of from about 180° F. to about 200° F. to at least substantially reduce the lipase activity of the milled whole grain mixture.

7. A method for making a dry, whole grain hot cereal product as claimed in claim 2 wherein the milled whole grain mixture is heated to a temperature of from about 180° F. to about 200° F. to at least substantially reduce the lipase activity of the milled whole grain mixture.

8. A method for making a dry, whole grain hot cereal product as claimed in claim 5 wherein the coarse fraction is heated to a temperature of from about 180° F. to about 200° F. to at least substantially reduce the lipase activity of the coarse fraction.

9. A method for making a dry, whole grain hot cereal product as claimed in claim 7 wherein said heating results in a degree of gelatinization of starch contained in the stabilized whole grain particulate mixture of less than about 10% as measured by differential scanning calorimetry (DSC), and the stabilized whole grain particulate mixture is hydratable by admixing the particulate mixture with water and applying external heat to cook the particulate mixture into a creamy whole grain hot cereal which is at least substantially lump-free.

10. A method for making a dry, whole grain hot cereal product as claimed in claim 8 wherein said heating results in a degree of gelatinization of starch contained in the stabilized whole grain particulate mixture of less than about 10% as measured by differential scanning calorimetry (DSC), and the stabilized whole grain particulate mixture is hydratable by admixing the particulate mixture with water and applying external heat to cook the particulate mixture into a creamy whole grain hot cereal which is at least substantially lump-free.

11. A method for making a dry, whole grain hot cereal product as claimed in claim 1 wherein said heating comprises pressure cooking to at least substantially gelatinize starch contained in the stabilized whole grain particulate mixture, and the stabilized whole grain particulate mixture is hydratable into a creamy whole grain hot cereal which is at least substantially lump-free by admixing the particulate mixture with hot water without the need to apply external heat to cook the particulate mixture.

12. A method for making a dry, whole grain hot cereal product as claimed in claim 2 wherein the milled whole grain mixture is admixed with water and said heating at least substantially gelatinizes starch contained in the whole grain mixture to obtain a cooked, stabilized whole grain particulate mixture, the cooked, stabilized whole grain particulate mixture is ground, the ground, cooked whole grain particulate mixture is flaked, and the flaked, stabilized whole grain particulate mixture is hydratable into a creamy whole grain hot cereal which is at least substantially lump-free by admixing the flaked, particulate mixture with hot water without the need to apply external heat to cook the particulate mixture.

13. A method for making a dry, whole grain hot cereal product as claimed in claim 4 wherein the milled whole grain mixture is admixed with water and cooked to at least substantially gelatinize starch contained in the whole grain mixture to obtain a cooked, stabilized whole grain particulate mixture, the cooked, stabilized whole grain particulate mixture is ground, the ground, cooked whole grain particulate mixture is flaked, and the flaked, stabilized whole grain particulate mixture is hydratable into a creamy whole grain hot cereal which is at least substantially lump-free by admixing the flaked, particulate mixture with hot water without the need to apply external heat to cook the particulate mixture.

14. A method for making a dry, whole grain hot cereal product as claimed in claim 5 wherein the milled whole grain mixture is admixed with water and cooked to at least substantially gelatinize starch contained in the whole grain mixture to obtain a cooked, stabilized whole grain particulate mixture, the cooked, stabilized whole grain particulate mixture is ground, the ground, cooked whole grain particulate mixture is flaked, and the flaked, stabilized whole grain particulate mixture is hydratable into a creamy whole grain hot cereal which is at least substantially lump-free by admixing the flaked, particulate mixture with hot water without the need to apply external heat to cook the particulate mixture.

15. A method for making a dry, whole grain hot cereal product as claimed in claim 12 wherein the milled whole grain mixture is cooked in the presence of disodium phosphate and an enzyme to reduce cooking time.

16. A method for making a dry, whole grain hot cereal product as claimed in claim 13 wherein the milled whole grain mixture is cooked in the presence of disodium phosphate and an enzyme to reduce cooking time.

17. A method for making a dry, whole grain hot cereal product as claimed in claim 14 wherein the milled whole grain mixture is cooked in the presence of disodium phosphate and an enzyme to reduce cooking time.

18. A method for making a dry, whole grain hot cereal product as claimed in claim 12 wherein said heating comprises pressure cooking of the milled whole grain mixture at a temperature of about 230° F. (110° C.) to about 248° F. (120° C.), at a pressure of about 10 psig to about 15 psig, for about 10 minutes to about 30 minutes.

19. A method for making a dry, whole grain hot cereal product as claimed in claim 13 wherein said cooking comprises pressure cooking of the milled whole grain mixture at a temperature of about 230° F. (110° C.) to about 248° F. (120° C.), at a pressure of about 10 psig to about 15 psig, for about 10 minutes to about 30 minutes.

20. A method for making a dry, whole grain hot cereal product as claimed in claim 14 wherein said cooking comprises pressure cooking of the milled whole grain mixture at a temperature of about 230° F. (110° C.) to about 248° F. (120° C.), at a pressure of about 10 psig to about 15 psig, for about 10 minutes to about 30 minutes.

21. A method for making a dry, whole grain hot cereal product as claimed in claim 1 wherein the whole grain hot cereal product is a whole wheat hot cereal product.

22. A dry, whole wheat hot cereal product which readily hydrates into a creamy whole wheat hot cereal comprising a stabilized, milled whole grain particulate mixture comprising endosperm, bran, and germ wherein the endosperm, the bran and the germ have been milled to obtain a milled whole grain mixture having a particle size distribution of 100% by weight through a No. 16 (1,190 micron) U.S. Standard Sieve, and less than or equal to about 7% by weight through a No. 100 (149 micron) U.S. Standard Sieve, and the endosperm, the bran and the germ have been heated to at least substantially reduce the lipase activity of the milled whole wheat mixture, the stabilized whole wheat particulate mixture being readily hydratable by heating in the presence of water into a creamy whole wheat hot cereal which is at least substantially lump-free.
